(19) United States
(12) Patent Application Publication
(10) Pub. No.: US 2026/0168388 A1
(43) Pub. Date: Jun. 18, 2026

(54) FAN BLADE FAIRING ASSEMBLY FOR AN AIRCRAFT PROPULSION SYSTEM

(71) Applicant: RTX Corporation, Farmington, CT (US)

(72) Inventor: Brian K. Holland, Mason, MI (US)

(21) Appl. No.: 18/979,215

(22) Filed: Dec. 12, 2024

(51) Int. Cl. F01D 11/00

(52) U.S. Cl. CPC F01D 11/008; F05D 2220/36; F05D 2240/80

(57) ABSTRACT

A fan blade fairing assembly for a gas turbine engine includes a fairing body, a replaceable component, and a bonding assembly. The fairing body includes an outer wall, a first sidewall, and a second sidewall. The outer wall extends between and connects the first sidewall and the second sidewall. The replaceable component is bonded onto the fairing body. The bonding assembly includes an electrically debonding adhesive, a first conductive member, and a second conductive member. The electrically debonding adhesive bonds the replaceable component onto the fairing body. The electrically debonding adhesive is disposed between the first conductive member and the second conductive member.

### BACKGROUND

### 1. Technical Field

This disclosure relates generally to aircraft propulsion systems and, more particularly, to fan blade fairing assemblies for gas turbine engine bladed fan rotors.

### 2. Background Information

A fan for an aircraft propulsion system may include fairing assemblies between fan blades of the fan to guide air flow through the fan. Various fairing assemblies are known in the art. While these known fairing assemblies may be suitable for their intended purposes, there is always room in the art for improvement.

### SUMMARY

According to an aspect of the present disclosure, a fan blade fairing assembly for a gas turbine engine includes a fairing body, a replaceable component, and a bonding assembly. The fairing body includes an outer wall, a first sidewall, and a second sidewall. The outer wall extends between and connects the first sidewall and the second sidewall. The replaceable component is bonded onto the fairing body. The bonding assembly includes an electrically debonding adhesive, a first conductive member, and a second conductive member. The electrically debonding adhesive bonds the replaceable component onto the fairing body. The electrically debonding adhesive is disposed between the first conductive member and the second conductive member.

In any of the aspects or embodiments described above and herein, the fairing body may include a fiber-reinforced composite material, and the electrically debonding adhesive may bond the replaceable component onto the fiber-reinforced composite material.

In any of the aspects or embodiments described above and herein, the fiber-reinforced composite material may include a plurality of fiberglass plies.

In any of the aspects or embodiments described above and herein, one or both of the first conductive member or the second conductive member may include a metallic foil tab.

In any of the aspects or embodiments described above and herein, the replaceable component may be an elastomeric seal bonded to one of the first sidewall or the second sidewall by the electrically debonding adhesive.

In any of the aspects or embodiments described above and herein, the first conductive member may include a first metallic foil mounted to the one of the first sidewall or the second sidewall, the second conductive member may include a second metallic foil mounted to the elastomeric seal, and the electrically debonding adhesive may be disposed between and contacting the first metallic foil and the second metallic foil.

In any of the aspects or embodiments described above and herein, the first conductive member may include a first conductive tab, the second conductive member may include a second conductive tab, and a portion of each of the first conductive tab and the second conductive tab may be disposed outside of a bond interface formed by the one of the first sidewall or the second sidewall, the elastomeric seal, and the electrically debonding adhesive.

In any of the aspects or embodiments described above and herein, the fan blade fairing assembly my further include a mounting assembly forming a pivot axis of the fan blade fairing assembly, the mounting assembly may include a lug and a bushing mounted within the lug, the lug may form an inner surface, the bushing may form an outer surface, the inner surface and the outer surface may extend circumferentially about the pivot axis, the replaceable component may be the bushing, and the outer surface may be bonded to the inner surface by the electrically debonding adhesive.

In any of the aspects or embodiments described above and herein, the first conductive member may include a conductive tab disposed between the inner surface and the electrically debonding adhesive.

In any of the aspects or embodiments described above and herein, the bushing may form the second conductive member.

According to another aspect of the present disclosure, a fan blade fairing assembly for a gas turbine engine includes a fairing body, a first seal, a second seal, and a bushing. The fairing body forms an outer wall, a first sidewall, a second sidewall, and a mounting assembly lug. The outer wall extends between and connects the first sidewall and the second sidewall. The mounting assembly lug is disposed between the first sidewall and the second sidewall. The first seal is bonded onto the first sidewall. The second seal is bonded onto the second sidewall. The bushing is mounted within the mounting assembly lug. Each of the first seal, the second seal, and the bushing is bonded to the fairing body by a bonding assembly including an electrically debonding adhesive.

In any of the aspects or embodiments described above and herein, the fairing body may include a fiber-reinforced composite material forming the outer wall, the first sidewall, the second sidewall, and the mounting assembly lug.

In any of the aspects or embodiments described above and herein, the bonding assembly may include a conductive tab extending outside of a bond interface formed by the fairing body and the bonding assembly.

In any of the aspects or embodiments described above and herein, the conductive tab may be a metallic foil tab.

According to another aspect of the present disclosure, a gas turbine engine for an aircraft propulsion system includes a bladed fan rotor. The bladed fan rotor is configured for rotation about an axis of the gas turbine engine. The bladed fan rotor includes a hub, a plurality of fan blades, and a fan blade fairing assembly. The fan blade fairing assembly is mounted on the hub between a pair of circumferentially adjacent fan blades of the plurality of fan blades. The fan blade fairing assembly includes a fairing body, a replaceable component, and a bonding assembly. The fairing body includes an outer wall, a first sidewall, and a second sidewall. The outer wall extends between and connects the first sidewall and the second sidewall. The outer wall forms an inner radial air flow surface bounding an air flow passage between the pair of circumferentially adjacent fan blades. The replaceable component is bonded onto the fairing body. The bonding assembly bonds the replaceable component onto the fairing body. The bonding assembly includes an electrically debonding adhesive.

In any of the aspects or embodiments described above and herein, the fairing body may include a fiber-reinforced composite material, and the bonding assembly may bond the replaceable component onto the fiber-reinforced composite material.

In any of the aspects or embodiments described above and herein, the fiber-reinforced composite material may include a plurality of fiberglass plies.

In any of the aspects or embodiments described above and herein, the replaceable component may be an elastomeric seal bonded to one of the first sidewall or the second sidewall by the bonding assembly, and the elastomeric seal may be disposed at one of the pair of circumferentially adjacent fan blades.

In any of the aspects or embodiments described above and herein, the fan blade fairing assembly may further include a mounting assembly forming a pivot axis between the fan blade fairing assembly and the hub, the mounting assembly may include a lug and a bushing mounted within the lug, the lug may form an inner surface, the bushing may form an outer surface, the inner surface and the outer surface may extend circumferentially about the pivot axis, the replaceable component may be the bushing, and the outer surface may be bonded to the inner surface by the bonding assembly.

In any of the aspects or embodiments described above and herein, the fairing body may form the lug.

According to another aspect of the present disclosure, a component assembly includes a first component, a second component, and a bonding assembly. The first component includes a fiber-reinforced composite body. The second component is bonded onto the fiber-reinforced composite body. The bonding assembly bonds the second component onto the fiber-reinforced composite body. The bonding assembly includes an electrically debonding adhesive, a first conductive member, and a second conductive member. The electrically debonding adhesive is disposed between the first conductive member and the second conductive member.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 illustrates a perspective view of an aircraft including a propulsion system, in accordance with one or more embodiments of the present disclosure.

FIG. 2 schematically illustrates a cutaway, side view of an aircraft propulsion system including a gas turbine engine, in accordance with one or more embodiments of the present disclosure.

FIG. 3 illustrates a perspective view of a fan section of the gas turbine engine showing a portion of a bladed fan rotor, in accordance with one or more embodiments of the present disclosure.

FIG. 4 illustrates a perspective view a fan blade fairing assembly, in accordance with one or more embodiments of the present disclosure.

FIG. 5 illustrates a top view of the fan blade fairing assembly, in accordance with one or more embodiments of the present disclosure.

FIG. 6 illustrates a cutaway, side view of the fan blade fairing assembly, in accordance with one or more embodiments of the present disclosure.

FIG. 7 illustrates a cross-sectional view of the fan blade fairing assembly taken along Line 7-7 of FIG. 6, in accordance with one or more embodiments of the present disclosure.

FIG. 8 schematically illustrates a bonding assembly including an electrically debonding adhesive, in accordance with one or more embodiments of the present disclosure.

FIG. 9 illustrates a cutaway view of a portion of the fairing assembly including the bonding assembly, in accordance with one or more embodiments of the present disclosure.

FIG. 10 illustrates a side view of the fairing assembly including the bonding assembly, in accordance with one or more embodiments of the present disclosure.

FIG. 11 illustrates a cutaway view of the fairing assembly including the bonding assembly bonding a bushing to the fairing body of the fairing assembly, in accordance with one or more embodiments of the present disclosure.

### DETAILED DESCRIPTION

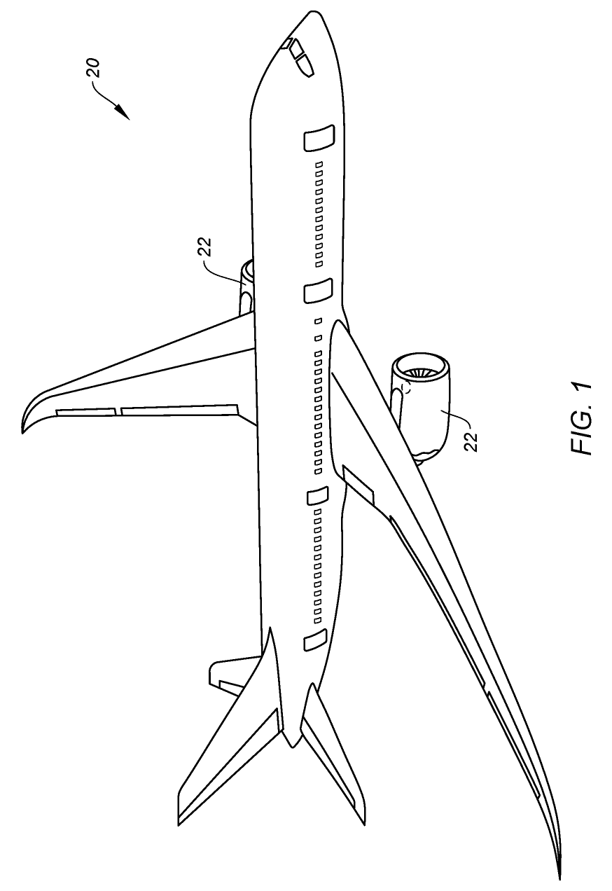

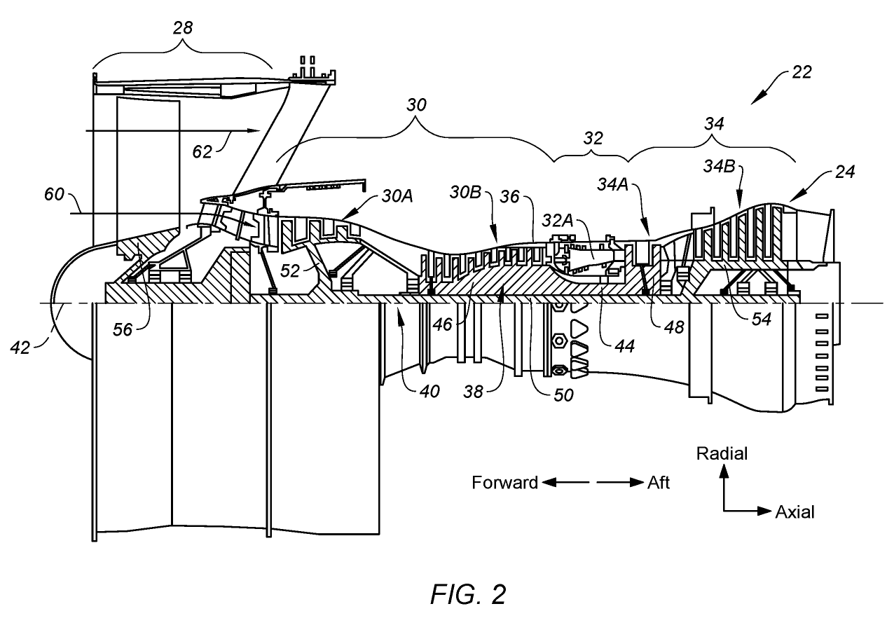

FIG. 1 illustrates an aircraft 20 including a propulsion system 22. Briefly, the aircraft 20 may be a fixed-wing aircraft (e.g., an airplane), a rotary-wing aircraft (e.g., a helicopter), a tilt-rotor aircraft, a tilt-wing aircraft, or another aerial vehicle. Moreover, the aircraft 20 may be a manned aerial vehicle or an unmanned aerial vehicle (UAV, e.g., a drone). FIG. 2 schematically illustrates a cutaway, side view of the propulsion system 22. The propulsion system 22 of FIG. 2 includes a gas turbine engine 24.

The gas turbine engine 24 of FIG. 2 is configured as a multi-spool turbofan gas turbine engine 24. However, while the following description and accompanying drawings may refer to the turbofan gas turbine engine 24 of FIG. 2 as an example, it should be understood that aspects of the present disclosure may be equally applicable to other types of gas turbine engines including, but not limited to, a turboshaft gas turbine engine, a turboprop gas turbine engine, a turbojet gas turbine engine, a propfan gas turbine engine, or an open rotor gas turbine engine.

The gas turbine engine 24 of FIG. 2 includes a fan section 28, a compressor section 30, a combustor section 32, a turbine section 34, and an engine static structure 36. The compressor section 30 includes a low-pressure compressor (LPC) 30A and a high-pressure compressor (HPC) 30B. The combustor section 32 includes a combustor 32A (e.g., an annular combustor). The turbine section 34 includes a high-pressure turbine (HPT) 34A and a low-pressure turbine (LPT) 34B.

Components of the fan section 28, the compressor section 30, and the turbine section 34 form a first rotational assembly 38 (e.g., a high-pressure spool) and a second rotational assembly 40 (e.g., a low-pressure spool) of the gas turbine engine 24. The first rotational assembly 38 and the second rotational assembly 40 are mounted for rotation about a rotational axis 42 (e.g., an axial centerline) of the gas turbine engine 24 relative to the engine static structure 36.

The first rotational assembly 38 includes a first shaft 44, a bladed first compressor rotor 46 for the high-pressure compressor 30B, and a bladed first turbine rotor 48 for the high-pressure turbine 34A. The first shaft 44 interconnects the bladed first compressor rotor 46 and the bladed first turbine rotor 48.

The second rotational assembly 40 includes a second shaft 50, a bladed second compressor rotor 52 for the low-pressure compressor 30A, a bladed second turbine rotor 54 for the low-pressure turbine 34B, and a bladed fan rotor 56 for the fan section 28. The second shaft 50 interconnects the bladed second compressor rotor 52 and the bladed second turbine rotor 54. The second shaft 50 may additionally interconnect the bladed fan rotor 56 with the bladed second compressor rotor 52 and the bladed second turbine rotor 54. Alternatively, the second shaft 50 may be coupled with the bladed fan rotor 56 by a gear assembly (e.g., a reduction gear box (RGB)). The first shaft 44 and the second shaft 50 are concentric and configured to rotate about the rotational axis 42. The present disclosure, however, is not limited to concentric configurations of the first shaft 44 and the second shaft 50.

The engine static structure 36 may include one or more engine cases, cowlings, bearing assemblies, inner fixed structures, and/or other non-rotating structures configured to house and/or support (e.g., rotationally support) components of the gas turbine engine sections 28, 30, 32, 34. The engine static structure 36 may form an exterior (e.g., an outer radial portion) of the gas turbine engine 24.

In operation of the gas turbine engine 24, ambient air is directed through the fan section 28 and into a core flow path 60 (e.g., an annular flow path) and a bypass flow path 62 (e.g., an annular flow path) by rotation of the bladed fan rotor 56. Air flow along the core flow path 60 is compressed by the low-pressure compressor 30A and the high-pressure compressor 30B, mixed and burned with fuel in the combustor 32A, and then directed through the high-pressure turbine 34A and the low-pressure turbine 34B. The bladed first turbine rotor 48 and the bladed second turbine rotor 54 rotationally drive the first rotational assembly 38 and the second rotational assembly 40, respectively, in response to the combustion gas flow through the high-pressure turbine 34A and the low-pressure turbine 34B.

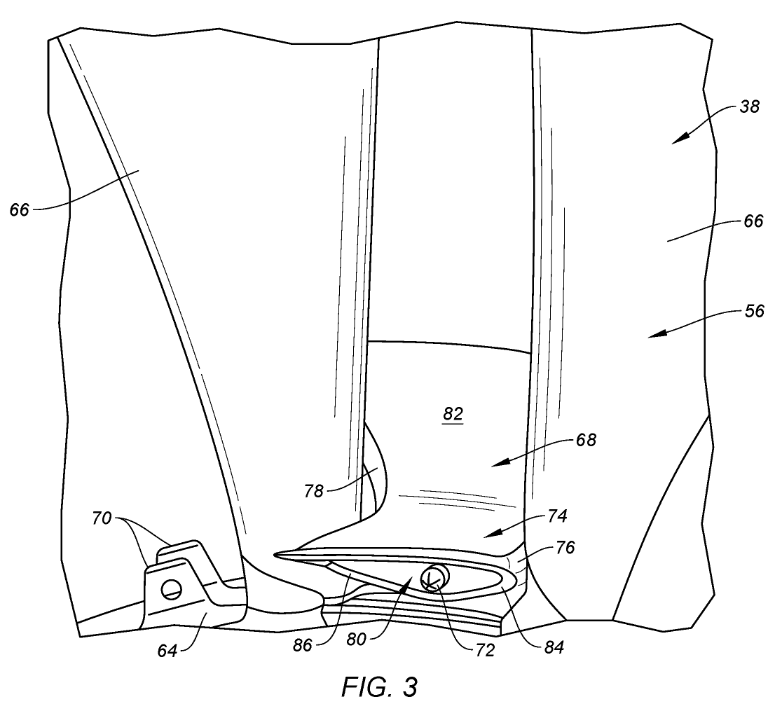

FIG. 3 illustrates a perspective view of the fan section 28 showing a portion of the bladed fan rotor 56. The bladed fan rotor 56 of FIG. 3 includes a hub 64, a plurality of fan blades 66, and a plurality of fan blade fairing assemblies 68 (sometimes referred to as “fan platforms”). The fan blades 66 are mounted onto and extend outward from (e.g., radially outward from) the hub 64. The fan blades 66 are arranged on the hub 64 as a circumferential array forming an air flow passage between each circumferentially-adjacent pair of the fan blades 66. One of the fan blade fair assemblies 68 is mounted to the hub 64 between each circumferentially-adjacent pair of the fan blades 66 to form an inner radial air flow surface bounding the air flow passage between the fan blades 66. For example, each of the fan blade fairing assemblies 68 may be mounted (e.g., pivotably mounted) to one or more brackets 70 of the hub 64 by one or more pins 72.

Each of the fan blade fairing assemblies 68 includes a fairing body 74, a first seal 76, a second seal 78, and one or more mounting assemblies 80. The fairing body 74 includes an outer wall 82, a first sidewall 84, and a second sidewall 86. The outer wall 82 extends between the circumferentially-adjacent pair of fan blades 66 to form the inner radial air flow surface bounding the air flow passage between the fan blades 66. The outer wall 82 extends between and connects the first sidewall 84 and the second sidewall 86. The first seal 76 and the second seal 78 are each disposed between the fairing body 74 and one of the fan blades 66. The mounting assemblies 80 may be formed, in part, by the fairing body 74, for example, between (e.g., circumferentially between) the first sidewall 84 and the second sidewall 86. The mounting assemblies 80 may be configured to receive the brackets 70 and the pins 72 to facilitate mounting the fan blade fairing assembly 68 to the hub 64.

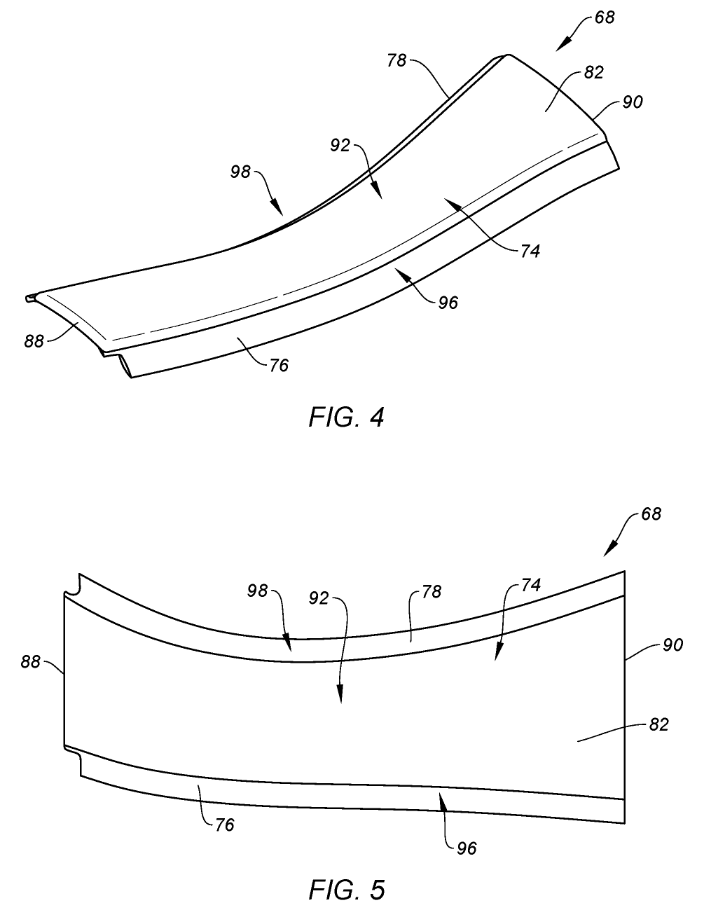

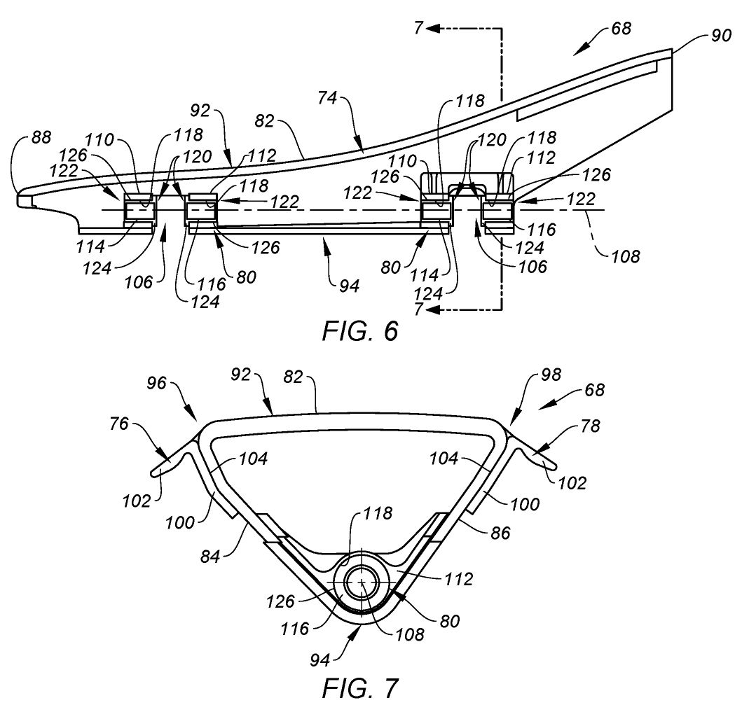

FIGS. 4-7 illustrate the fan blade fairing assembly 68 in greater detail. FIG. 4 illustrates a perspective view of the fan blade fairing assembly 68. FIG. 5 illustrates a top view of the fan blade fairing assembly 68. FIG. 6 illustrates a cutaway, side view of the fan blade fairing assembly 68. FIG. 7 illustrates a cross-sectional view of the fan blade fairing assembly taken along Line 7-7 of FIG. 6. The fairing body 74 extends (e.g., axially extends) between and to a first axial end 88 of the fairing body 74 and a second axial end 90 of the fairing body 74. The fairing body 74 extends (e.g., radially extends) between and to an outer radial end 92 of the fairing body 74 and an inner radial end 94 of the fairing body 74. The fairing body 74 extends (e.g., circumferentially extends) between and to a first circumferential end 96 of the fairing body 74 and a second circumferential end 98 of the fairing body 74. The terms “axial,” “radial,” and “circumferential,” and variations thereof, are used in connection with the fan blade fairing assembly 68 and the fairing body 74 with respect to a typical orientation of the fan blade fairing assembly 68 within the gas turbine engine 24 (e.g., relative to the rotational axis 42), and should not be considered otherwise limiting on the fan blade fairing assembly 68 structure.

The outer wall 82 extends along the outer radial end 92 between and to the first axial end 88 and the second axial end 90 and between and to the first circumferential end 96 and the second circumferential end 98. The first sidewall 84 extends from the outer wall 82 at (e.g., on, adjacent, or proximate) the first circumferential end 96. For example, the first sidewall 84 may extend from the outer wall 82 to or toward the inner radial end 94. The first sidewall 84 extends between and to or substantially between and to the first axial end 88 and the second axial end 90. The second sidewall 86 extends from the outer wall 82 at (e.g., on, adjacent, or proximate) the second circumferential end 98. For example, the second sidewall 86 may extend from the outer wall 82 to or toward the inner radial end 94. The second sidewall 86 may intersect the first sidewall 84 at (e.g., on, adjacent, or proximate) the inner radial end 94. The second sidewall 86 extends between and to or substantially between and to the first axial end 88 and the second axial end 90.

The fairing body 74 is formed wholly or in substantial part by a fairing body material. The fairing body material is a fiber-reinforced composite material (e.g., a composite material made of a polymer matrix reinforced with fibers) such as, but not limited to, fiberglass, carbon-fiber reinforced polymers (e.g., aramid or para-aramid fibers), or the like. For example, the fairing body material may include by a plurality of plies (e.g., layers) of a fiber-reinforced plastic material molded together to form the fairing body 74 including along exterior surfaces of the fairing body 74.

The first seal 76 and the second seal 78 are mounted on (e.g., bonded to) the fairing body 74. The first seal 76 is mounted on the first sidewall 84, for example, at (e.g., on, adjacent, or proximate) the outer radial end 92. the second seal 78 is mounted on the second sidewall 86, for example, at (e.g., on, adjacent, or proximate) the outer radial end 92. The first seal 76 and the second seal 78 extend between and to or substantially between and to the first axial end 88 and the second axial end 90. Each of the first seal 76 and the second seal 78 includes a bonding segment 100 and a sealing segment 102. The bonding segment 100 extends along and contacts the fairing body 74 (e.g., the first sidewall 84 or the second sidewall 86). For example, the bonding segment 100 may form a bonding surface 104 disposed at (e.g., on, adjacent, or proximate) the fairing body 74. The sealing segment 102 extends outward from the bonding segment 100. The sealing segment 102 projects outward (e.g., circumferentially outward) from the fairing body 74, for example, to or toward a circumferentially-adjacent one of the fan blades 66 (see FIG. 3). The first seal 76 and the second seal 78 may be formed by an elastomeric material such as rubber (e.g., silicone rubber), a thermoplastic material, or another suitable resilient sealing material.

Each of the mounting assemblies 80 forms a slot 106 configured to receive the one or more brackets 70 and one of the pins 72 to facilitate mounting (e.g., pivotably mounting) the fairing assembly 68 to the hub 64. The mounting assemblies 80 of FIGS. 4-7 are configured to each receive one of the pins 72 along a pivot axis 108 common to each of the mounting assemblies 80. The fairing assembly 68 of FIGS. 4-7 include two of the mounting assemblies 80 (e.g., a first axial mounting assembly and a second axial mounting assembly); however, the present disclosure is not limited to any particular quantity of the mounting assemblies 80 for the fairing assembly 68. The mounting assemblies 80 are disposed at (e.g., on, adjacent, or proximate) the inner radial end 94. The mounting assemblies 80 may be disposed between (e.g., circumferentially between) and/or supported by the first sidewall 84 and the second sidewall 86. Each of the mounting assemblies 80 includes a first lug 110, a second lug 112, a first bushing 114, and a second bushing 116. The fairing body 74 forms the first lug 110 and the second lug 112. The first lug 110 and the second lug 112 are axially spaced from one another along the pivot axis 108. Each of the first lug 110 and the second lug 112 forms a cylindrical inner surface 118 extending circumferentially about (e.g., completely around) the pivot axis 108. Each of the first bushing 114 and the second bushing 116 extends (e.g., axially extends) along the pivot axis 108 between and to a first axial end 120 of the bushing 114, 116 and a second axial end 122 of the bushing 114, 116. Each of the first bushing 114 and the second bushing 116 includes a flange 124 and a cylindrical outer surface 126. The flange 124 is disposed at (e.g., on, adjacent, or proximate) the first axial end 120 and extends radially outward from the outer surface 126. The outer surface 126 extends axially between and to the flange 124 and the second axial end 122. The outer surface 126 extends circumferentially about (e.g., completely around) the pivot axis 108. The first bushing 114 is mounted within the first lug 110. For example, the outer surface 126 may be mounted on (e.g., bonded to) the inner surface 118. The flange 124 axially abuts the fairing body 74 at (e.g., on, adjacent, or proximate) the inner surface 118. The flange 124 may additionally or alternatively be mounted on (e.g., bonded to) the fairing body 74 where the flange 124 axially abuts the fairing body 74. Similarly, the second bushing 116 is mounted within the second lug 112. For example, the outer surface 126 may be mounted on (e.g., bonded to) the inner surface 118. The flange 124 axially abuts the fairing body 74 at (e.g., on, adjacent, or proximate) the inner surface 118. The flange 124 may additionally or alternatively be mounted on (e.g., bonded to) the fairing body 74 where the flange 124 axially abuts the fairing body 74.

After a period of operation of the gas turbine engine 24, for example at periodic maintenance intervals, components of the fairing assemblies 68 may require repair or replacement. For example, replaceable components of the fairing assemblies 68 such as, but not limited to, the seals 76, 78 and the bushings 114, 116, which may gradually become worn or otherwise degraded during gas turbine engine 24 operation and may be replaced (and discarded) while the fairing body 74 of the fairing assemblies 68 may be saved for continued operational use. However, these replaceable components may conventionally be bonded directly to a fiber-reinforced plastic material of a fairing body by one or more adhesives, and removal of the replaceable components and associated adhesives may be complicated, time consuming, and expensive. For example, removal of the replaceable components and particularly the adhesive from the underlying fiber-reinforced plastic material of the fairing body may require extensive mechanical removal techniques such as, but not limited to, media blasting, mechanical abrasion, scraping, drilling, etc. However, technicians must also take care during performance of the mechanical removal techniques that the outer fiber-reinforced plastic material plies of the fairing body are not delaminated or otherwise damaged.

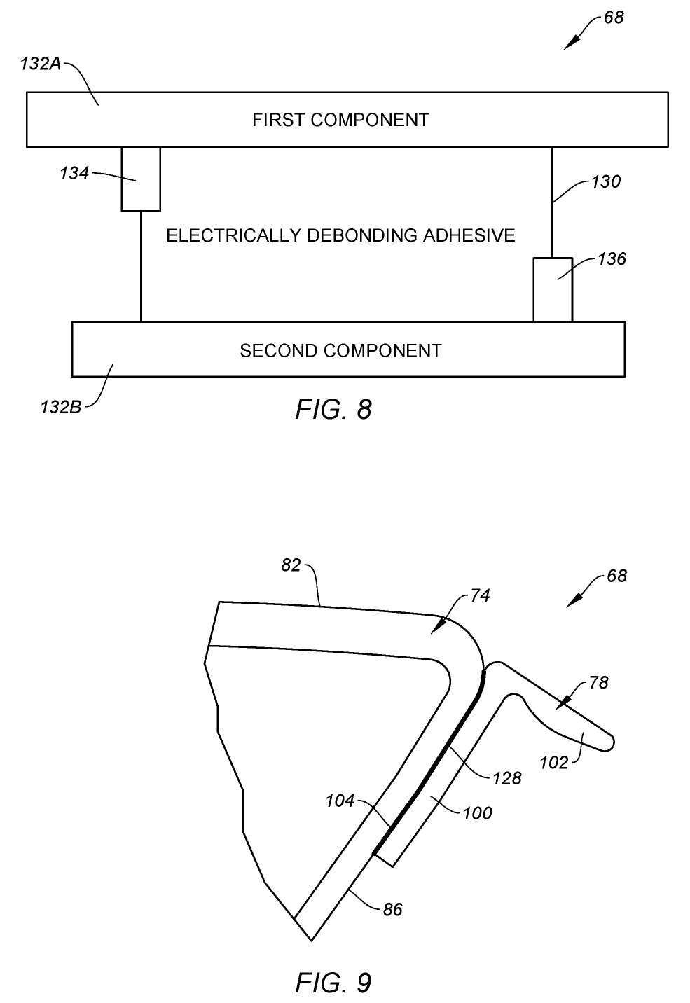

FIG. 8 schematically illustrates a bonding assembly 128 configured to facilitate attachment (e.g., bonding) and subsequent removal of a first component 132A and a second component 132B. The bonding assembly 128 of the present disclosure includes an electrically debonding adhesive 130. The bonding assembly 128 may be of particular utility for bonding together the fairing body 74 (e.g., the fiber-reinforced composite material body), for example the first component 132A, with one or more replaceable components 132B such as, but not limited to, the seals 76, 78 and the bushings 114, 116. While the bonding assembly 128 is described herein with respect to the fairing assembly 68, the seals 76, 78, and the bushings 114, 116, the present disclosure is not limited to these foregoing exemplary applications of the bonding assembly 128. For example, aspects of the present disclosure bonding assembly 128 may be equally applicable to other aircraft propulsion system component assemblies where periodic component detachment and/or replacement may be necessary and the component assemblies may typically operate within a suitable temperature range for the electrically debonding adhesive 130 (e.g., less than about 230 Fahrenheit (F)). The bonding assembly 128 further includes a first electrically conductive member 134 (e.g., a metallic conductive member) and a second electrically conductive member 136 (e.g., a metallic conductive member). In some embodiments, one of the conductive members 134, 136 may be the component 132B itself (e.g., a metallic or otherwise electrically conductive component). The electrically debonding adhesive 130 of the present disclosure is configured to debond through application of a low-voltage electrical current therethrough, for example, in the range of about 10 volts (V) to about 50 V. Debonding refers to a characteristic of the electrically debonding adhesive 130 wherein the electrically debonding adhesive 130 loses adhesion to a surface of one or both of the first conductive member 134 or the second conductive member 136, causing the electrically debonding adhesive 130 to separate from the surface, thereby breaking an adhesive joint between the electrically debonding adhesive 130 and the surface. In particular, the application of the low-voltage current through the electrically debonding adhesive 130 (e.g., from the first conductive member 134 to the second conductive member 136) may facilitate an electrochemical reaction (e.g., a faradaic reaction) at the adhesive-conductor interface, causing the electrically debonding adhesive 130 to debond from the conductive member 134, 136 surface(s). A non-limiting example of the electrically debonding adhesive may be sold under the trade name “ElectRelease E4” by EIC Laboratories of Norwood, Massachusetts.

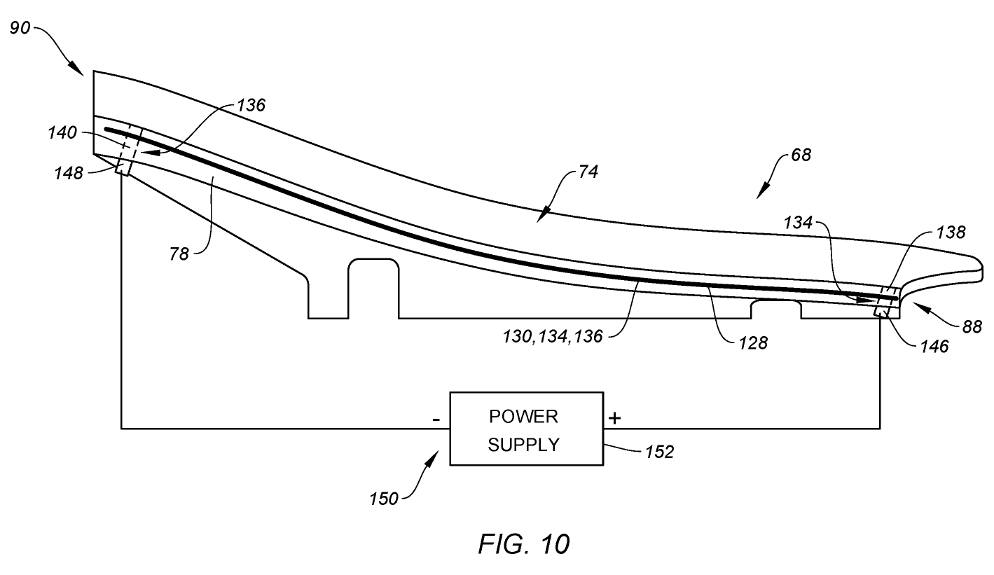

Referring to FIGS. 9 and 10, the first seal 76 and the second seal 78 may each be mounted on (e.g., bonded to) the fairing body 74 by the bonding assembly 128. FIG. 9 illustrates a cutaway view of a portion of the fairing assembly 68 showing the second seal 78 mounted to the second sidewall 86 by the bonding assembly 128. FIG. 10 illustrates a side view of the fairing assembly 68 showing the second seal 78 mounted to the second sidewall 86 by the bonding assembly 128. Of course, the description herein for the second seal 78 mounted to the second sidewall 86 by the bonding assembly 128 is equally applicable to the first seal 76 and the first sidewall 84. The bonding assembly 128 may extend (e.g., axially extend) between the second seal 78 and the second sidewall 86 along all or substantially all of an axial span of the second seal 78.

The first conductive member 134 and the second conductive member 136 of FIGS. 9 and 10 includes a first metallic foil 138 and a second metallic foil 140, respectively. The metallic foil 138, 140 may be, for example, an aluminum foil; however, the present disclosure is not limited to any particular metallic material of the metallic foil 138, 140. The term foil, as used herein, should be understood to refer to a thin metallic sheet having a thickness less than or equal to about 10 mils (0.25 millimeters) and, more typically, between about 0.1 mils and 2.0 mils. The electrically debonding adhesive 130 is disposed contacting and adhered to the first metallic foil 138 and the second metallic foil 140.

The first conductive member 134 further includes a first electrically conductive tab 146. The first conductive tab 146 is disposed in contact with and electrically connected to the first metallic foil 138. For example, the first conductive tab 146 may be disposed between the first metallic foil 138 and the electrically debonding adhesive 130. At least a substantial portion of the first conductive tab 146 extends outside of the bond interface, for example, between the first metallic foil 138 and the fairing body 74 to facilitate access to the first conductive tab 146 for a subsequent debonding process. Similarly, the second conductive member 136 further includes a second electrically conductive tab 148. The second conductive tab 148 is disposed in contact with and electrically connected to the second metallic foil 140. For example, the second conductive tab 148 may be disposed between the second metallic foil 140 and the electrically debonding adhesive 130. At least a substantial portion of the second conductive tab 148 extends outside of the bond interface, for example, between the second metallic foil 140 and the second seal 78 to facilitate access to the first conductive tab 146 for a subsequent debonding process. The first conductive tab 146 and the second conductive tab 148 may each be formed from a metallic foil which may be the same as or different than the first metallic foil 138 and the second metallic foil 140. The first conductive tab 146 and the second conductive tab 148, however, are not limited to any particular electrically conductive material or configuration. As shown in FIG. 10, the first conductive tab 146 and the second conductive tab 148 may be disposed at (e.g., on, adjacent, or proximate) axially opposite ends of the bonding assembly 128. For example, the first conductive tab 146 may be disposed at (e.g., on, adjacent, or proximate) the first axial end 88 and the second conductive tab 148 may be disposed at (e.g., on, adjacent, or proximate) the second axial end 90, or vice versa.

FIG. 10 further schematically illustrates an exemplary debonding system 150 for debonding the electrically debonding adhesive 130 to facilitate separation of the second seal 78 from the fairing body 74 (e.g., the second sidewall 86). The debonding system 150 includes a power supply 152 configured to supply a low-voltage electrical current (e.g., between 10 and 50 V) through the electrically debonding adhesive 130. The power supply 152 may be a battery, an electrical generator, or any other suitable low-voltage power supply. The power supply 152 may be electrically connected to the first conductive tab 146 (e.g., at a positive terminal) and to the second conductive tab 148 (e.g., at a negative terminal) by any suitable electrical connector. Application of the low-voltage electrical current through the electrically debonding adhesive 130 (e.g., for a duration between about 1 second and 1 minute) facilitates debonding of the electrically debonding adhesive 130 from the first metallic foil 138 and the second metallic foil 140, thereby facilitating separation of the second seal 78 from the fairing body 74.

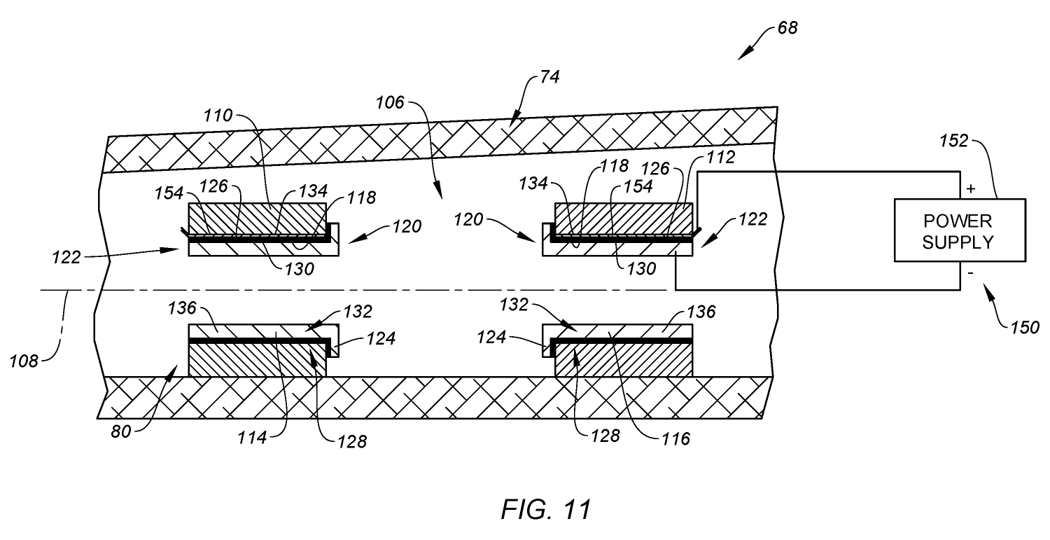

Referring to FIG. 11, the first bushing 114 and the second bushing 116 may each be mounted within (e.g., bonded to) the first lug 110 and the second lug 112 by a first bonding assembly 128, 128A and a second bonding assembly 128, 128B, respectively. The first conductive member 134 of FIG. 11 includes an electrically conductive tab 154. The bushing 114, 116 of FIG. 11 (e.g., metallic, electrically conductive bushings) form the second conductive member 136 of the bonding assembly 128 of FIG. 11. The electrically debonding adhesive 130 is disposed between (e.g., sandwiched between), contacting, and adhered to the lug 110, 112 (e.g., the inner surface 118) and the bushing 114, 116 (e.g., the outer surface 126). The electrically debonding adhesive 130 may additionally disposed between (e.g., sandwiched axially between), contacting, and adhered to the lug 110, 112 and the flange 124. The conductive tab 154 is disposed between the electrically debonding adhesive 130 and the lug 110, 112 (e.g., the inner surface 118) along a circumferential portion of the bond interface between the electrically debonding adhesive 130 and the lug 110, 112. The conductive tab 154 may extend axially between the electrically debonding adhesive 130 and the lug 110, 112, for example, from the flange 124 to (and past) the second axial end 122. At least a substantial portion of the conductive tab 154 extends outside of the bond interface, for example, at (e.g., on, adjacent, or proximate) the second axial end 122 (e.g., axially opposite the flange 124), to facilitate access to the conductive tab 154 for a subsequent debonding process. Similar to the first conductive tab 146 and the second conductive tab 148 (see FIG. 10), the conductive tab 154 may be formed from a metallic foil. The conductive tab 154, however, is not limited to any particular electrically conductive material or configuration.

FIG. 11 further schematically illustrates the exemplary debonding system 150 for debonding the electrically debonding adhesive 130 to facilitate separation of the first bushing 114 and the second bushing 116 from the first lug 110 and the second lug 112, respectively. The power supply 152 may be electrically connected to the conductive tab 154 (e.g., at a positive terminal) and to the bushing 114, 116 (e.g., at a negative terminal) by any suitable electrical connector. Application of the low-voltage electrical current through the electrically debonding adhesive 130 (e.g., for a duration between about 1 second and 1 minute) facilitates debonding of the electrically debonding adhesive 130 from the lug 110, 112 and the bushing 114, 116, thereby facilitating separation the bushing 114, 116 from the lug 110, 112.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms "a," "an," and "the" refer to one or more than one, unless the context clearly dictates otherwise. For example, the term "comprising a specimen" includes single or plural specimens and is considered equivalent to the phrase "comprising at least one specimen." The term "or" refers to a single element of stated alternative elements or a combination of two or more elements unless the context clearly indicates otherwise. As used herein, "comprises" means "includes." Thus, "comprising A or B," means "including A or B, or A and B," without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected, or the like may include permanent, removable, temporary, partial, full and/or any other possible attachment option.

The terms “substantially,” “about,” “approximately,” and other similar terms of approximation used throughout this patent application are intended to encompass variations or ranges that are reasonable and customary in the relevant field. These terms should be construed as allowing for variations that do not alter the basic essence or functionality of the invention. Such variations may include, but are not limited to, variations due to manufacturing tolerances, materials used, or inherent characteristics of the elements described in the claims, and should be understood as falling within the scope of the claims unless explicitly stated otherwise.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures--such as alternative materials, structures, configurations, methods, devices, and components, and so on--may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

1. A fan blade fairing assembly for a gas turbine engine, the fan blade fairing assembly comprising:
a fairing body including an outer wall, a first sidewall, and a second sidewall, the outer wall extending between and connects the first sidewall and the second sidewall;
a replaceable component bonded onto the fairing body; and
a bonding assembly including an electrically debonding adhesive, a first conductive member, and a second conductive member, the electrically debonding adhesive bonding the replaceable component onto the fairing body, the bonding assembly the electrically debonding adhesive disposed between the first conductive member and the second conductive member.

2. The fan blade fairing assembly of claim 1, wherein the fairing body includes a fiber-reinforced composite material, and the electrically debonding adhesive bonds the replaceable component onto the fiber-reinforced composite material.

3. The fan blade fairing assembly of claim 2, wherein the fiber-reinforced composite material includes a plurality of fiberglass plies.

4. The fan blade fairing assembly of claim 1, wherein one or both of the first conductive member or the second conductive member includes a metallic foil tab.

5. The fan blade fairing assembly of claim 1, wherein the replaceable component is an elastomeric seal bonded to one of the first sidewall or the second sidewall by the electrically debonding adhesive.

6. The fan blade fairing assembly of claim 5, wherein the first conductive member includes a first metallic foil mounted to the one of the first sidewall or the second sidewall, the second conductive member includes a second metallic foil mounted to the elastomeric seal, and the electrically debonding adhesive is disposed between and contacting the first metallic foil and the second metallic foil.

7. The fan blade fairing assembly of claim 5, wherein the first conductive member includes a first conductive tab, the second conductive member includes a second conductive tab, and a portion of each of the first conductive tab and the second conductive tab is disposed outside of a bond interface formed by the one of the first sidewall or the second sidewall, the elastomeric seal, and the electrically debonding adhesive.

8. The fan blade fairing assembly of claim 1, further comprising a mounting assembly forming a pivot axis of the fan blade fairing assembly, the mounting assembly including a lug and a bushing mounted within the lug, the lug forming an inner surface, the bushing forming an outer surface, the inner surface and the outer surface extending circumferentially about the pivot axis, wherein the replaceable component is the bushing, and the outer surface is bonded to the inner surface by the electrically debonding adhesive.

9. The fan blade fairing assembly of claim 8, wherein the first conductive member includes a conductive tab disposed between the inner surface and the electrically debonding adhesive.

10. The fan blade fairing assembly of claim 9, wherein the bushing forms the second conductive member.

11. A fan blade fairing assembly for a gas turbine engine, the fan blade fairing assembly comprising:
a fairing body forming an outer wall, a first sidewall, a second sidewall, and a mounting assembly lug, the outer wall extending between and connects the first sidewall and the second sidewall, the mounting assembly lug disposed between the first sidewall and the second sidewall;
a first seal bonded onto the first sidewall;
a second seal bonded onto the second sidewall; and
a bushing mounted within the mounting assembly lug;
each of the first seal, the second seal, and the bushing bonded to the fairing body by a bonding assembly including an electrically debonding adhesive.

12. The fan blade fairing assembly of claim 11, wherein the fairing body includes a fiber-reinforced composite material forming the outer wall, the first sidewall, the second sidewall, and the mounting assembly lug.

13. The fan blade fairing assembly of claim 11, wherein the bonding assembly includes a conductive tab extending outside of a bond interface formed by the fairing body and the bonding assembly.

14. The fan blade fairing assembly of claim 13, wherein the conductive tab is a metallic foil tab.

15. A gas turbine engine for an aircraft propulsion system, the gas turbine engine comprising:
a bladed fan rotor configured for rotation about an axis of the gas turbine engine, the bladed fan rotor including a hub, a plurality of fan blades, and a fan blade fairing assembly, the fan blade fairing assembly mounted on the hub between a pair of circumferentially adjacent fan blades of the plurality of fan blades, the fan blade fairing assembly including:
a fairing body including an outer wall, a first sidewall, and a second sidewall, the outer wall extending between and connects the first sidewall and the second sidewall, the outer wall forming an inner radial air flow surface bounding an air flow passage between the pair of circumferentially adjacent fan blades;
a replaceable component bonded onto the fairing body; and
a bonding assembly bonding the replaceable component onto the fairing body, the bonding assembly including an electrically debonding adhesive.

16. The gas turbine engine of claim 15, wherein the fairing body includes a fiber-reinforced composite material, and the bonding assembly bonds the replaceable component onto the fiber-reinforced composite material.

17. The gas turbine engine of claim 16, wherein the fiber-reinforced composite material includes a plurality of fiberglass plies.

18. The gas turbine engine of claim 15, wherein the replaceable component is an elastomeric seal bonded to one of the first sidewall or the second sidewall by the bonding assembly, the elastomeric seal disposed at one of the pair of circumferentially adjacent fan blades.

19. The gas turbine engine of claim 15, wherein the fan blade fairing assembly further includes a mounting assembly forming a pivot axis between the fan blade fairing assembly and the hub, the mounting assembly includes a lug and a bushing mounted within the lug, the lug forms an inner surface, the bushing forms an outer surface, the inner surface and the outer surface extend circumferentially about the pivot axis, the replaceable component is the bushing, and the outer surface is bonded to the inner surface by the bonding assembly.

20. The gas turbine engine of claim 19, wherein the fairing body forms the lug.
